(19) United States
(12) Patent Application Publication
(10) Pub. No.: US 2005/0154621 A1
(43) Pub. Date: Jul. 14, 2005

(54) Voice enabled interactive travel information conversion system

(76) Inventors: Mark William Birkhead, San Diego, CA (US); Michael William Birkhead, Copperopolis, CA (US)

Correspondence Address: Mark Birkhead;3830 Valley Centre Drive, PMB 705-345, San Diego, CA, 92130, US

(21) Appl. No.: 10/753,600

(22) Filed: Jan. 9, 2004

(51) Int. Cl. G06F 17/60

(52) U.S. Cl. 705/5

(57) ABSTRACT

A voice enabled interactive (i.e., automatic) travel information system and method for converting and transmitting online travel information events into real-time, dynamically generated interactive speech and voice recognition responses for delivery to telephone and mobile devices of a user. Files and documents are processed through speech recognition and text-to-speech systems for converting content, speech and audio into generated voice instructions. The documents contain software developed instructions that generate and process speech recognition responses and text to speech transmissions that are capable of being transported between users and the interactive travel via a mobile device or telephone of the user in an interactive manner in order to create, transmit, receive and modify online travel information events and member profile information for the purposes of processing and interacting with online travel information events.

### BACKGROUND OF THE INVENTION

1. Field of the Invention

The present invention relates to a voice enabled interactive travel information conversion system. More specifically, the present invention relates to a system and method for converting online and electronic travel information into interactive voice responses and speech transmissions for user interaction.

2. Background Art

Prior to the introduction of the Internet, telephone and other mobile technologies, most forms of accurate travel information resided within public or private companies information systems and data repositories. Travel information is traditionally constructed in text or electronic format that is accessed by calling a travel agent, travel service company, (i.e., airline, cruise line, railway, etc.), accessing the Internet or by reading a periodic publication containing travel information. The aggregation of travel of information by a single travel information supplier presented additional access obstacles related to the distribution channels and data formats of the information aggregator, as well as the issues of cross-sharing time sensitive pricing information.

Accurate travel information has played a critical role in the economic and social evolution of society throughout time. Travel is a key component to the daily function of society. People need to be at certain places at certain times. Accurate travel information requires that travel information be correct, timely, (i.e., available in real-time) and easily accessible. Until the invention of telephones, the Internet, computers, databases and other mobile technologies, print distribution was the primary means of communicating and distributing travel information. The invention of the telephone initially extended the print distribution model. The invention of computers, electronic data and the Internet further extended print and telephone distribution models. Generally, there are four models for accessing, distributing and interacting with travel information: print publications, Internet, telephone and mobile data devices capable of interfacing with travel information data sources.

Most travel information is now available in electronic format, however it is not easily accessible due to the various mediums by which travel information is distributed. Every electronic distribution medium requires a specific type of access device designed to receive and transmit data and information in the correct format acceptable to the selected medium of distribution. Automated data transmission and retrieval systems were developed as a result of utilizing computers and the Internet as the primary means for broadcasting and receiving travel information, as well as enabling a majority of the interactions with and between users in the public and travel information providers. Public users use the Internet and telephone to locate travel data repositories to access and interact with travel information.

Under the typical travel information access model, a user accesses travel information by locating a travel information provider on the Internet, through printed publication, by telephone or by physically traveling to a facility where travel information is distributed. A user may also directly contact the travel service company through the selected distribution medium of the travel service company, provided that the user possesses the correct access device. Problematic to the logistical process of locating travel information is the aggregation of all travel information by a single information provider. Many competing travel service providers limit the number and kinds of businesses to which they will distribute travel information. Therefore it may be necessary for a user to contact multiple travel information providers and travel service companies to locate desired travel information. No system prior to this invention has provided users with the ability to simultaneously connect calls and electronic data between different travel information providers and travel service companies using voice recognition technologies while maintaining the same session information for the duration of the call. Strategic corporate alliances and competing travel service companies limit the ability of travel information providers to distribute and connect travel information for every type of travel service available. Most travel information providers use limited data aggregation sources and distribution mediums, thereby requiring users to own or have access to multiple devices that facilitate access to different travel information system distribution mediums. Many travel information providers are market specific in that they only provide travel information for a specific type of travel. Some travel information providers only serve specific airlines and travel companies or are limited to the number and kinds of travel providers that can be used, while others may serve only rail travel or water based travel information.

Under the typical travel information distribution model, travel service companies and travel information providers produce and distribute travel information pertaining to destinations, arrival and departure schedules, seating arrangements, occupancy availability, date availability, pricing, specials etc., to be released to market. The information is maintained by the travel information service provider as well as the travel service company. The travel service company originates and publishes travel information in electronic and print format, and distributes it to the public through print, Internet and other methods of electronic distribution. Travel service companies distribute information for routes and destinations for which they provide travel service. As a general rule, travel service companies do not provide information from or about their competitors. However, travel information providers will distribute travel information from any travel service company from which it can acquire travel information.

At present, print based travel information can be accessed by physically traveling to a repository or service provider that distributes travel information or by accessing a distribution channel that delivers printed travel information. Online based travel information can only be transmitted through protocols that require a PC, client-server, or browser compliant device that is capable of receiving and/or transmitting http protocol based online travel information. Access to travel information is nearly always accomplished by users using a PC to access travel information via the Internet. However, there are many limitations that are imposed upon users by making travel information available only by accessing the Internet through a PC or wireless device configured with the necessary software to view and interact with travel information and content. If a user cannot gain access to a PC, he cannot access the travel information. The end result in many instances is that the user and travel service company suffer economic loss because of the inability of the user to access the Internet and locate accurate travel information.

Due to the limitations of current technology, in order for a user to have unlimited access to travel information for the duration of an inquiry wherein the user is accessing travel information resources, the user would be required to carry on his person or have immediate access to some or all printed travel information publications or have constant access to or carry on his person a PC with Internet data access. Such a PC must be capable of the same coverage of data reception and transmission as those associated with wireless and terrestrial based telephone communication systems. The required PC would also need to roam from one wireless and cellular coverage area to another without the requirement of being reconfigured across individual networks to gain access to the Internet.

The present travel information distribution model is not efficient and in many instances infeasible due to the many practical technological limitations of modern IP, terrestrial and wireless networks, geographical location and registration requirements, security and access controls and transportability, whereby to prevent real-time access to current travel information. While wireless connectivity is pervasive throughout the world, transmission of protocols capable of carrying Internet content and http-based packets is not available in many areas. Additionally, many individuals will not adopt mobile phones as Internet browsers due to issues regarding the size and functionality of mobile phones and devices. Further the large printed volumes of travel information and related materials are too cumbersome to carry on one's person.

Computers are not sufficiently portable to be transported on one's person for any reasonable length of time. Mobile devices have not attained universal adoption in the market and suffer from extensive usability and feature set limitations. Printed publications are too numerous, large and heavy. Separate subscriptions are required for each category of device connectivity, making using multiple wireless devices economically unsound. Most mobile device services are not currently configured to share a wireless account between a wireless telephony device and a mobile data device. Consequently, there is not an effective solution available to travel information users that allows for pervasive interaction with travel information sources in a real-time environment without extensive additional hardware and third-party wireless data service expenses.

Travel information users want access to current and accurate travel information at all times. Travel information users also want travel information available to them in a format that is easy access, simple to use and available nearly anywhere in the world by means of a readily available telephone device. Accordingly, what is required is a system wherein any person can interact with travel information, from any travel information provider and travel service company, in real-time though terrestrial based telephones, cellular phones, satellite phones and voice enabled mobile devices at anytime across any supporting wireless or terrestrial based telephone network.

### SUMMARY OF THE INVENTION

In general terms, disclosed herein is a voice enabled interactive online travel information system and method that enables travel information users the ability to receive and transmit real-time travel information and commands through speech recognition and voice enabled systems. The voice enabled online travel information conversion system permits the user to interact with electronic, online travel information by means of a telephone. The nature of the interaction may involve the reception and transmission of queries and responses generated by the user and an existing online travel information service during the lifecycle of an interaction that includes voice responses or other human understandable and generated audio data formats.

These and other needs are fulfilled by the voice enabled interactive travel information conversion system disclosed herein, whereby a user of an interactive travel information system can interact in real-time with travel information providers and travel service companies using a telephone to interface with travel information conversion systems capable of transforming travel information into and from interactive voice responses. The interactive travel information conversion system further allows users the ability to access member profile information as well as the ability to search and browse online travel information service providers using a telephone.

### BRIEF DESCRIPTION OF THE DRAWINGS

FIG. 1 is a block diagram illustrating the system and subsystem level elements of the voice enabled interactive travel information conversion system of this invention;

FIG. 2 is a flow chart illustrating the main menu and system interaction types offered by a voice enabled interactive travel information system;

FIG. 3 is a flow chart illustrating the process of an inbound (user initiated) interaction with information events and/or objects offered by the voice enabled, interactive travel information system;

FIG. 4 is a flow chart illustrating the method of outbound (system initiated) interaction with information events generated by the voice enabled interactive travel information system and received by a telephone device of a user;

FIG. 5 is a flow chart illustrating the process of an inbound (user initiated) interaction with the voice enabled interactive travel information system;

FIG. 6 is a flow chart illustrating the process of an outbound (system initiated) interaction with the voice enabled interactive travel information system;

FIG. 7 is a flow chart illustrating the normal cycle of data and control to and from the user and the voice enabled interactive travel information system of FIG. 1.

### DETAILED DESCRIPTION

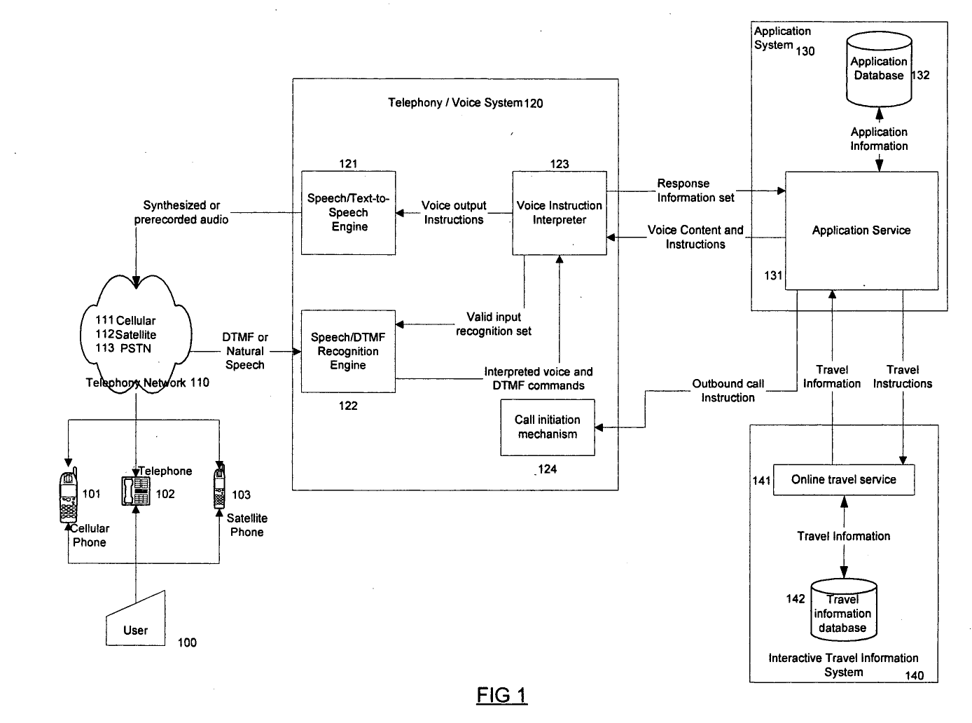

FIG. 1 of the drawings shows a block diagram that is representative of a travel information system having interactive speech and voice recognition capabilities to enable real-time user participation from telephone and mobile devices. The interactive travel information system of FIG. 1 is adapted to convert online and electronic content and other information containing travel information into interactive voice responses that are accessible to users by means of a terrestrial telephone system or mobile device such as, for example, a wireless phone, PDA, or other device that is capable of such interaction.

More particularly, the voice enabled interactive travel information conversion system of FIG. 1 includes a telephony/voice system 120. The telephony/voice system 120 is responsible for making the connection to an outside telephony network 110 that is capable of being interfaced with a terrestrial or mobile telephone system of a user 100. That is, system 120 must be capable of accepting inbound telephone calls from an outside telephony device as well as initiating outbound calls to the outside telephony device. System 120 must also be able to receive and understand commands and information that is received from an outside application system 131 in a manner that will be explained in greater detail hereinafter.

The telephony/voice system 120 includes a voice instruction interpreter 123 that is capable of receiving and understanding voice content and instructions in an electronic format that are indicative of input and output prompts that the telephony/voice system 120 will hear and provide. By way of an example, the voice instruction interpreter 123 may be a VXML browser that understands VXML (voice extensive markup language).

The telephony/voice system 120 also includes a speech/text-to-speech engine 121 that is capable of receiving and understanding voice (and other audio) instructions. The speech/text to speech engine also has the capability of converting the voice content and instructions (most commonly in the form of text) into human understandable speech and other audio to be output from the telephony/voice system 120.

In addition, the telephony/voice system 120 includes a speech/DTMF recognition engine 122 that is interfaced with the voice instruction interpreter 123. The speech/DTMF recognition engine 122 is capable of receiving and understanding speech and DTMF tones. Depending upon a set of predetermined vocabulary words, recognition engine 122 is able to provide an output in a proper grammatical form that best matches the incoming speech or DTMF tones generated by a user.

Lastly, telephony/voice system 120 also includes a call initiation mechanism 124 that is capable of receiving and understanding instructions to cause the system 120 to initiate an outbound telephone call to a user. The call initiation mechanism 124 is typically given a phone number to access and a starting point at which a communication will begin once a telephone call has been successfully completed.

Its simplest form, the voice instruction interpreter 123 of the telephony/voice system 120 receives voice information and instructions by which to indicate the output of the system 120, the input for which the system 120 should be listening, an order of interaction, and further actions to be taken depending upon the occurrence of certain predetermined events. The voice instruction interpreter 123 provides the speech/text-to-speech engine 121 with voice output instructions, typically in the form of text or audio files, to be output from system 120 to a telephony system. The voice instruction interpreter 123 also provides the speech/DTMF recognition engine 122 with an input recognition set, commonly in the form of a grammar, to identify those speech patterns to which engine 122 should be responsive. Depending upon whether engine 122 receives information that is understood, corresponding information is relayed to the voice instruction interpreter 123 in the form of a subset of the grammar with which engine 122 was provided. Such information may also indicate an error condition. The voice instruction interpreter 123, speech/text-to-speech engine 121, speech/DTMF recognition engine 122 and call initiation mechanism 124 interact with one another and systems outside the telephony/voice system 120 to manage the telephony portion of the interaction between the user and the interactive travel information system 140 by means of understanding human speech and DTMF key activations as well as the generation of output speech and other audio signals.

FIG. 1 also shows an application system 130 interconnected to the telephony/voice system 120. Application system 130 is responsible for managing and brokering the interface between telephony/voice system 120 and the interactive travel information system 140. In certain cases, it may be possible to eliminate the application system 130 entirely. That is to say, it is possible for the interactive travel information system 140 to provide output instructions directly to and receive instructions from the telephony/voice system 120. Nevertheless, some separate and intermediate component will still be required between the interactive travel information system 140 and telephony/voice system 120 that is capable of interacting with users.

The application system 130 includes an application service 131 which is capable of transmitting and receiving instructions and information to and from the telephony/voice system 120. Such information would include, but is not limited to, outbound call initiation instructions, VXML to control the interaction with a user, hang-up instructions, etc. The application service 131 is also responsible for transmitting and receiving instructions and information to and from the interactive travel information system 140.

The application system 130 also includes an application database 132. Application database 132 is responsible for the delivery and persistence of application information to and from the application service 131. Such application information can include user profile information, cached travel information, and the like.

The majority of the tasks performed by the application system 130 is completed by the application service 131. At the highest level, application service 131 is responsible for the translation of travel information and commands into telephony/voice specific information and commands and visa-versa. The application service 131 enables the flow of information between the voice/telephony system 120 and the interactive travel information system 140.

FIG. 1 also shows the interactive travel information system 140 interfaced with the application system 130. The interactive travel information system 140 is responsible for travel information management, user profile management, session specific information, etc. The interactive travel information system 140 must be capable of operating with the other systems 120 and 130 of FIG. 1 through a suitable application programming interface that is preferably travel specific.

The interactive travel information system 140 also includes a travel information database 142. Travel information database 142 is responsible for the delivery and persistence of travel information to and from the online travel service 141. Such travel information can include user profile information, account information, etc.

The majority of the tasks performed by the interactive travel information system 140 is completed by the online travel service 141. At the highest level, the online travel service 141 is responsible for making the online travel information automated. Online travel service 141 must be capable of performing all of the services and actions that are common to conventional online travel services.

A user 100 communicates with the telephony/voice system 120 by way of a telephony network 110. Telecommunications networks like that represented by reference numeral 110 are well known and, therefore, will not be described in detail herein. In general, however, the telephony network 110 is responsible for a connection between the user's telephony device and the telephony/voice system 120. By way of example, the telephony network 110 may include some or all of a cellular or mobile telephone network 111, a satellite telephone network 112, and/or a public switched telephony network (PSTN) 113.

A user 100 wishing to interact with an online travel information system communicates with the telephony/voice system 120 by way of the telephony network 110 and a suitable telephone device. Such a user activated telephone device by which to enable the user 100 to access the interactive travel information system 140 may include, but is not limited to, a mobile or cellular phone 101, a terrestrial telephone 102, or a satellite phone 103.

Although the telephony/voice system 120, the application system 130 and the interactive travel information system 140 of FIG. 1 are illustrated as separate systems, these systems are not necessarily limited by physical hardware boundaries. That is to say, each system could reside on and be run by the same computer. Moreover, the software used to control such a computer in the voice enabled online travel information system of this invention could be written as a single monolithic program. On the other hand, the systems 120, 130 and 140 of the voice enabled interactive travel information system of FIG. 1 are not required to be located on a single machine. By way of example, the travel database 142 of the interactive travel information system 140 could be distributed across a series of interlinked machines which span the globe. Therefore, it is to be understood that the components, systems and subsystems of the voice enabled interactive travel information system of FIG. 1 are illustrated merely to denote the most logical boundaries so that the construction, organization and interconnection may be more easily understood.

In this same regard, it should also be understood that the directional arrows illustrated between the systems 120, 130 and 140 denote the most logical information flow path. However, the precise means for generating the information flow as well as the corresponding flow paths can be accomplished in different ways. For example, one directional arrow in FIG. 1 illustrates that travel information flows from the online travel service 141 of interactive travel information system 140 to the application service 131 of application system 130. The online travel service 141 can send travel information to a listening port on the application service 131 without ever having been prompted for said information (i.e., often referred to as a push by the online travel service to the application service), or the application service 131 can request certain information from the online travel service 141. Such requested information should be returned to the application service 131 in the reply generated by the online travel service 141 (i.e., often referred to as a pull by the application service from the online travel service).

What is more, other devices can be included in FIG. 1 to initiate information flow. For example, the delivery of information denoting that a particular user had requested information for a particular type of travel information can be accomplished in different ways. In a first case, a user 100 that is connected to the application system 130 through the telephony/voice system 120 could request, by means of his phone and voice, whether new information has been released about any selected type of travel information. This request would be translated and ultimately transferred to the application system 130 which eventually causes the application service 131 to request from the online travel service 141 information to identify whether the user 100 has new information. In the alternative, a timing mechanism could expire within the application service 131 at which time the application service will request from the online travel service 141 suitable information to identify whether the user 100 has new information. As an additional alternative, upon determining that the user 100 had new information, the online travel service 141 will push the information to the application service 131.

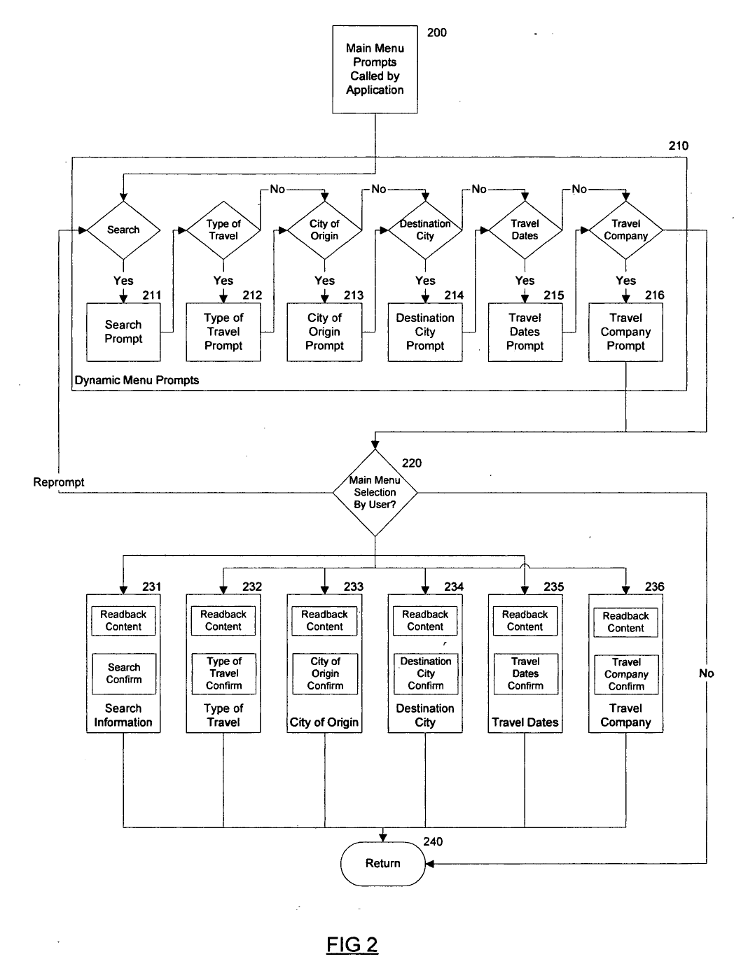

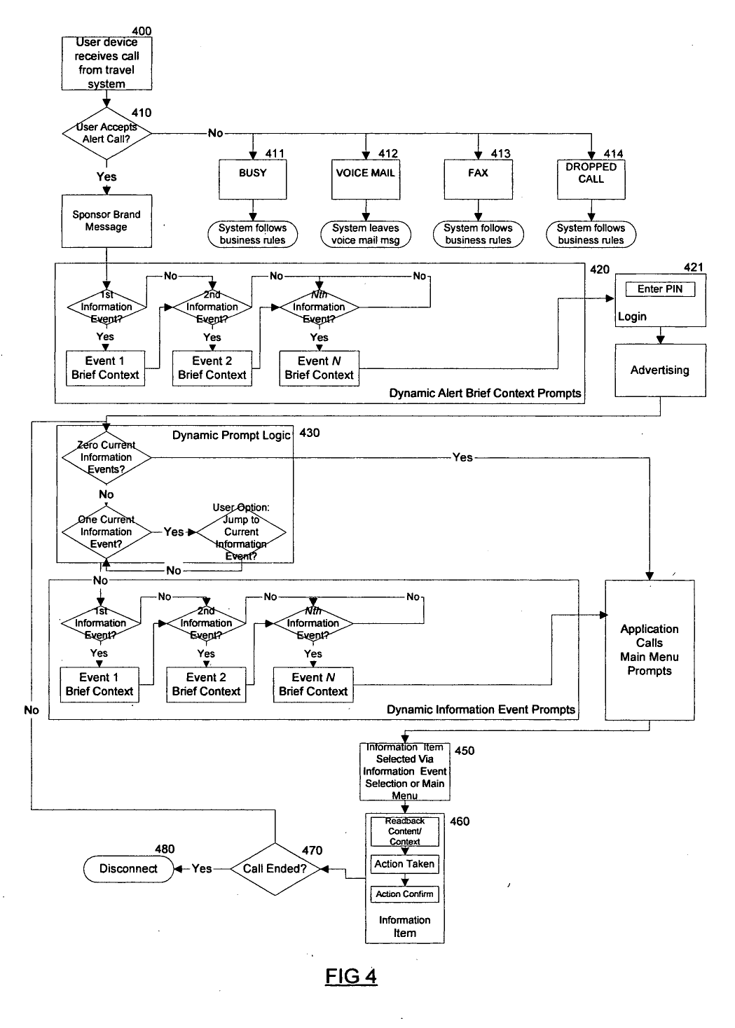

FIG. 2 of the drawings illustrates a main menu for the voice enabled interactive online travel of FIG. 1 and the travel information interaction types that are offered therein. The main menu of FIG. 2 is called up by the voice application during step 200 for presentation to the user either alone or as an integrated piece of a specialized interface that is presented within the context of a user initiated inbound (as is best in FIG. 4) call interaction. When the main menu is called by the voice enabled system, the user is presented with a series of dynamic prompts 210, the exact nature and number of which are determined by the particular profile of the user. If the user profile contains at least one of the travel information items that are appropriate to one of those specific prompts 210, then that prompt is read as an option in the main menu. If the user's profile does not contain the particular travel information item, then the prompt is not provided as an option in the main menu. Thus, it will be appreciated that the main menu will be relatively simple while still allowing a user all the possible options for interaction that are usual and appropriate.

A list of the travel interactive prompts available from the dynamic menu prompts 210 will now be described. By way of a first example, a search prompt 211 is provided such that the user can query the system for any travel information contained within the system or connected system.

A type of travel prompt 212 is provided in the event that the information requested from search prompt 211 has been returned and contains the type of travel requested by the user. Prompt 212 gives the user the option to listen to the types of travel available or browse any prompt in which the user would like to consider taking additional action.

A city of origin prompt 213 is provided when the travel information requested from search prompt 211 has been returned and contains a city of origin. Prompt 213 gives the user the option to listen to information pertaining to the city of origin or browse any prompt in which the user would like to consider taking additional action.

A destination city prompt 214 is provided when the travel information requested from search prompt 211 has been returned and contains a destination city. Prompt 214 gives the user the option to listen to information pertaining to the destination city or browse any prompt in which the user would like to consider taking additional action.

A travel dates prompt 215 is provided when the travel information requested from search prompt 211 has been returned and contains available travel dates. Prompt 215 gives the user the option to listen to the available travel dates or browse any prompt in which the user would like to consider taking additional action.

A travel company prompt 216 is provided when the travel information requested from search prompt 211 has been returned and contains a listing of travel companies. Prompt 216 gives the user the option to listen to available travel companies or browse any prompt in which the user would like to consider taking additional action.

If the user selects one of the dynamic menu prompts 210 during a selection step 220, then the user is presented with an information object within the selected category. If the user does not select one of the options offered by the prompts during the selection step 220, the interactive travel information system returns to the context that called the main menu to handle the original user input.

In the case where a selection is made by the user during step 220, one of a variety of corresponding options are available. By way of a travel information search process 231, the user is provided with a comprehensive definition of the search criteria from prompt 211. Upon selecting this object the interactive travel system then reads the relevant information. Once the action has been selected, the interactive travel information system confirms that the action was completed correctly and then returns to the context that called the main menu.

Another option that is available to the user is a type of travel process 232. If this option is selected, the user is provided with information pertaining to the available types of travel requested from search prompt 211. Upon selecting this object the interactive travel information system then reads the relevant information. Once the action has been selected, the interactive travel information system confirms that the action was successfully completed and then returns to the context that called the main menu.

Another option available to the user is the city of origin process 233. If this option is selected, the user is provided with a listing of origin cities for which travel information is available requested from search prompt 211. Upon selecting this object the interactive travel information system then reads the relevant information. Once the action has been selected, the interactive travel information system confirms that the action was successfully completed and then returns to the context that called the main menu.

Yet another option available to the user is the destination city process 234. If this option is selected, the user is provided with a brief list of destination cities for which travel information is available requested from search prompt 211. Upon selecting this object the interactive travel information system then reads the relevant information. Once the action has been selected, the interactive travel information system confirms that the action was successfully completed and then returns to the context that called the main menu.

Another option available to the user is the travel dates process 235. If selected, this process provides the user with a brief list of available travel dates requested from search prompt 211. Upon selecting this object the interactive travel information system then reads the relevant information. Once the action has been selected, the interactive travel information system confirms that the action was successfully completed and then returns to the context that called the main menu.

Another option available to the user is the travel company process 236. If selected, this process provides the user with a brief list of travel companies requested from search prompt 211. Upon selecting this object the interactive travel information system then reads the relevant information. Once the action has been selected, the interactive travel information system confirms that the action was successfully completed and then returns to the context that called the main menu.

After the user interaction with the main menu of FIG. 2 has been completed, or if one of the available information interaction categories or main menu items is not selected, the interactive travel system returns to the context that originally called these options during step 240.

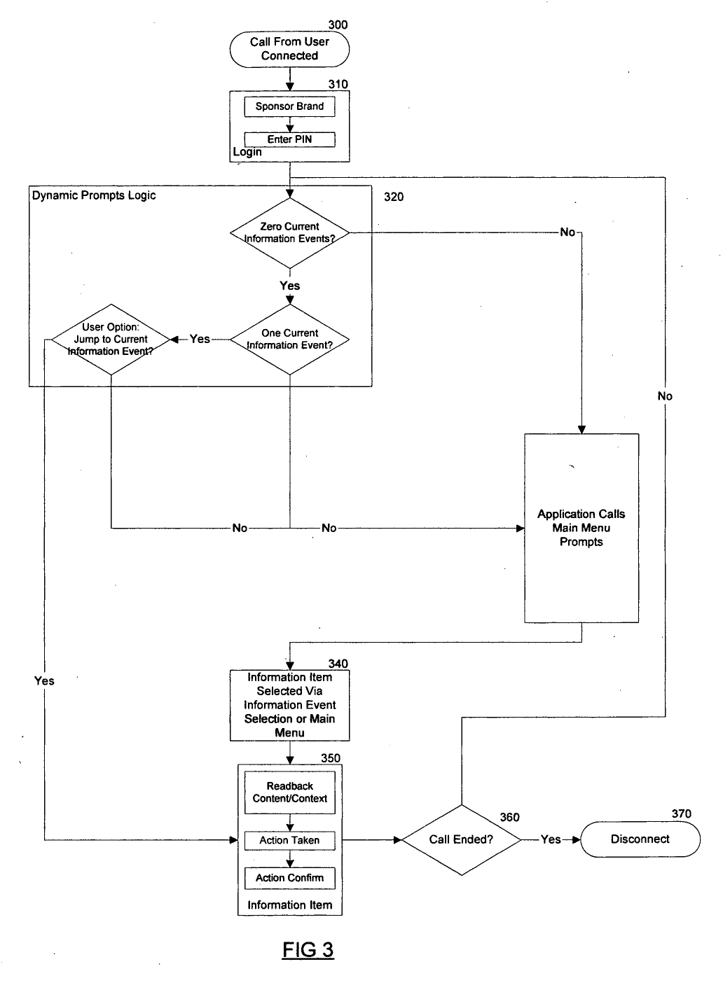

FIG. 3 of the drawings illustrates the process flow where a user calls the voice enabled interactive travel information system of FIG. 1 for the purpose of obtaining travel object information. The process of an inbound user initiated interaction 300 occurs when a call is connected from the user 100. That is, the user dials the application access phone number and the call connects via the telephony network 110 of FIG. 1. Following user connection, a user login 310 occurs, if required, during which the user is greeted by a suitable welcome message that may include an optional sponsor message as well as a prompt to enter the login ID of the user for the purpose of identification. User identification may also be accomplished through a user or caller ID or any other unique identification means, whether automated or manual. Once identified, the user must then enter a personal PIN security identifier, if required, that confirms the user's permission to access his account. The PIN, or password, step may be eliminated depending upon the security preferences of the user.

Following the user login 310, a series of automated logical steps occur by means of dynamic prompts logic 320. These steps lie in the background to determine the number of active information events that are relevant to or in the account of the user, providing that the user has established an account with the travel information provider and that the information service provider requires user accounts for interaction. Active information events are travel information service conditions that fulfill criteria to make them of timely interest to the user. Such active information events are the same conditions that enable navigation options in the main menu (of FIG. 2). However, this mechanism provides the user with links directly to the information that is most appropriate to the user's immediate interests. If the user has no active information events, he is directed to the main menu for navigation through the interactive travel information system options. If the user has only one active information event, he is provided with a prompt to jump directly to that information without having to listen to all of the available options of the main menu. If there is more than one active information event, then the user is taken to a dynamic list of information events 1 . . . N.

Following the dynamic prompts logic 320 are dynamic information event prompts 430. A user is read a list of events which are active information events in the user's account and from which the user can select one event for immediate access to the information without having to listen to all of the available options in the main menu. Once the dynamic list of information events has been completed, the user is taken to the main menu for other navigational options.

The next step of the inbound process flow is the information item selection step 340. An information item is selected via either one of a dynamic prompt for an active information event or through the main menu of FIG. 2. During this step, the user selects a particular information object for potential action.

During an information item step 350, and as was previously described when referring to FIG. 2, the user first evaluates relevant information for the item selected during the prior step 340 and then elects whether to interact with the selected item. If an election is made to interact, an input is completed and the system provides a message to confirm that action has been initiated and executed.

Following confirmation that an information action was consummated, the user may elect to end the call at step 360 or return to the application in order to select another information item for interaction through the main menu of FIG. 2. Should the user choose to end his call, the system simply disconnects the incoming line at step 370.

FIG. 4 of the drawings illustrates the process flow of the voice enabled interactive travel information system for transmitting an information event or events to the telephony device (designated 101, 102 and 103 in FIG. 1) of a user for the purpose of delivering travel information and/or enabling a user action relating to a travel information object. The user telephony device receives a call from the interactive travel information system at step 400. Next, the user decides whether to accept the call during step 410. If the user accepts the call, he enters the interactive travel information system and then may receive an optional sponsor message. If the call is not accepted, then the interactive travel may respond in any one of a variety of actions.

A first action 411 will occur when the telephone line is busy. If the line is busy, predetermined business rules that are appropriate for the interactive travel information system to determine whether the call is repeated or simply abandoned. Such business rules typically have a default condition but may also be configured by the user.

A second action 412 will occur if the telephone line is answered by a voicemail system. In this case, the business rules determine whether a message is left, the call is repeated, or the call is simply abandoned. Such business rules have a default condition but may also be configured by the user.

Another action 413 will occur if the telephone line is answered by a facsimile tone. In this case, the business rules determine whether a fax is transmitted with relevant travel information, the call is repeated, or the call is simply abandoned. Such business rules have a default condition but may also be configured by the user.

An additional action 414 will occur when the line is connected but dropped prior to login. Once again, the business rules determine whether the call is repeated or the call is abandoned. Such business rules have a default conditions but may also be configured by the user.

Provided that the user accepts the call from the application, he is prompted with a brief list of active information events 420 that triggered the outbound interaction between the interactive travel information system and the user. This list provides a brief summary of each information event so that the user may decide whether the event is worthy of entering the interactive travel information system for more information and potential actions. The list is kept relatively short for the purpose of speedy evaluation as well as security and privacy, since this information is provided to the user prior to a secure login to the interactive travel information system.

Once the user is alerted to an information event that merits his evaluation and potential action, he initiates a login process at step 421. Since the telephone call was made to a potentially secure telephone device, the user may elect to configure his account to require the entry of a secure PIN, or the user may set-up an account to enter the interactive travel information system directly. This setting may be user configurable or selected to accommodate standard travel information provider security policies. Following login, the user may be presented with an optional sponsor branding message.

After the user enters the interactive travel system, dynamic prompt logic 430 causes a series of automated logic steps to occur in the background to determine the number of active information events that are in the account of the user. Active information events are travel information conditions that fulfill criteria to make them of timely interest to the user. These events are the same conditions that enable navigation options in the main menu. However, the dynamic prompt logic 430 provides the user with links directly to the information that is most appropriate for the user's immediate attention.

In the event that the user has no active information events, he is taken directly to the main menu for navigation through the interactive travel information system options. If the user has only one information event, he is provided with a prompt to jump directly to that information without having to listen to all of the available options of the main menu. If there is more than one active information event, then the user is taken to a dynamic list 440 of information events 1 . . . N.

More particularly, the user is prompted with a list 440 of information events including a brief summary of the active information events in his account from which the user can select one event for immediate action without having to listen to all of the available options in the main menu. Once the dynamic list of option events is completed, the user is taken to the main menu for other navigational options.

In the case where the user selects an information item during step 450 via either a dynamic prompt for the list 440 of information events or through the main menu, he selects a particular information item and potential action. During an information item step 460, and as was previously described when referring to FIG. 2, the user first evaluates relevant information for the information item selected during step 450 and then elects whether to interact with the selected item. If an election is made to interact, an input is completed and the system provides a message to confirm that action has been initiated and executed.

Following confirmation that an information action was consummated, the user may elect to end the call at step 470 or return to the application in order to select another information item for interaction, either through the dynamic list 440 of information events or the main menu of FIG. 2. Should the user choose to end his call, the system simply disconnects the incoming line at step 480.

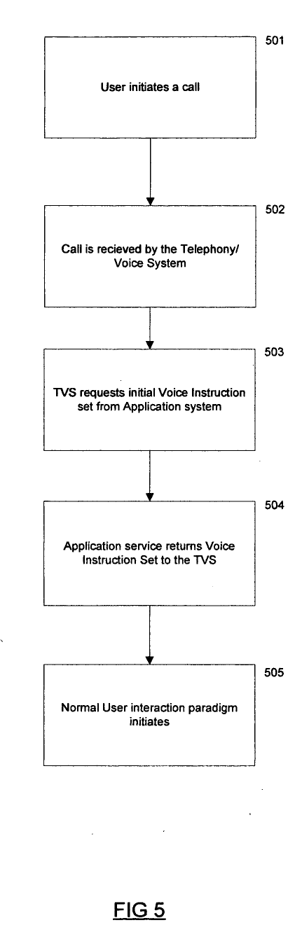

Turning to FIG. 5, there is shown a block diagram to illustrate the common data and control flow of a system inbound call initiation when a user calls the telephony/voice system 120 of FIG. 1. FIG. 5 demonstrates how the voice enabled interactive travel information system herein described reacts to an inbound call placed by a user and how the interactive travel information system eventually delivers the first pieces of interaction to the user. The steps which are indicative of the system inbound call interactions are described while referring concurrently to FIGS. 1 and 5 of the drawings.

A user 100 uses his telephone device 101, 102 or 103 to initiate a telephone call across any telephony network 110 of FIG. 1. The incoming telephone call is made during step 501 of FIG. 5 and received by the telephony/voice system 120 of FIG. 1 during step 502 of FIG. 5. The call is then accepted by the telephony/voice system 120.

During step 503 of FIG. 5, the telephony/voice system 120 requests an initial voice instruction set from the application system 130 of FIG. 1. This initial instruction set can be prestored or retrieved at the time of the inbound call. The initial request can also include information derived from the telephony network 110 (e.g., caller ID) and/or the number that was dialed by the user (DNIS).

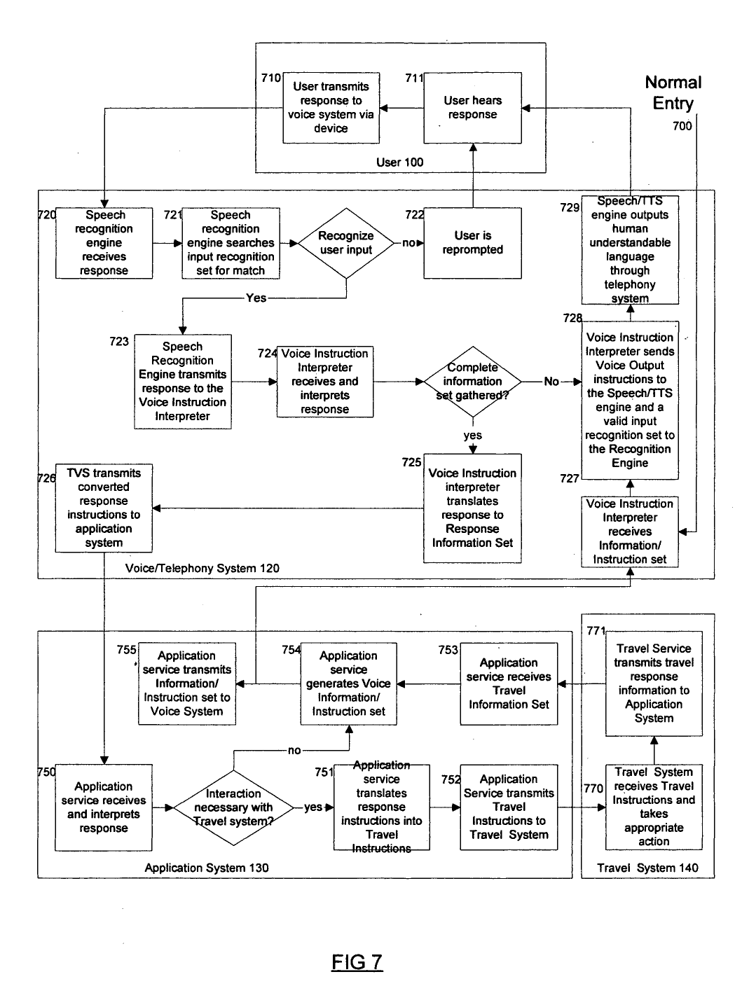

During step 504 of FIG. 5, the application service 131 of the application system 130 of FIG. 1 returns an initial voice instruction set to the telephony/voice system 120 which, in turn, is delivered to the voice instruction interpreter 123 thereof. By way of example only, the first instruction set may be a simple message (e.g., such as a welcoming message to the user 100) and does not require particular grammar. However, the returned instruction set from the telephony/voice system 120 could reflect information that was supplied by the telephony network 110. For example, if a caller ID was used, a specific welcome message or advertisement could be presented to the user 100 that was associated with the user's phone number. Lastly, during step 505 of FIG. 5, the normal user-to-system interaction begins (see line 700 in FIG. 7).

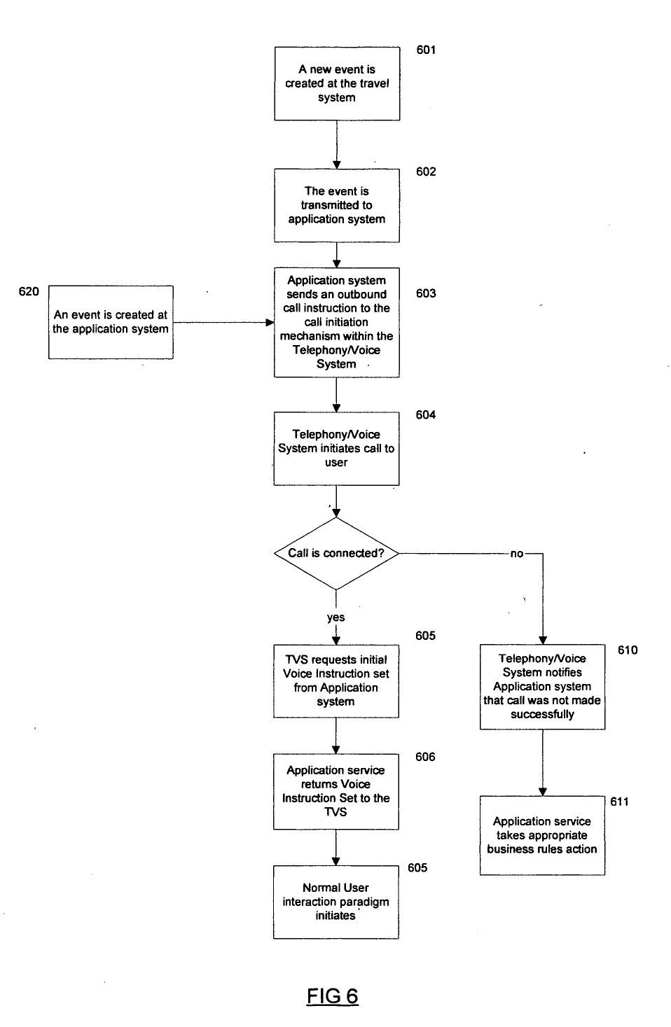

While FIG. 5 illustrates the common data and control flow of a system inbound call initiation, FIG. 6 of the drawings illustrates the common data and control flow of a system outbound call initiation. That is, FIG. 6 is a block diagram to illustrate the steps by which the voice enabled interactive travel information system places an outbound call to a user, how the outbound call is initiated, how the system eventually delivers the first pieces of interaction to the user, and how the system reacts in the case of an unsuccessful outbound call. The steps which are indicative of the system outbound call initiation are described while referring concurrently to FIGS. 1 and 6 of the drawings.

During the initial step 601 of FIG. 6, the interactive travel information system 140 of FIG. 1 creates an information event which must be delivered to the user 100. This event is transmitted to the application system 130 of FIG. 1 during step 602 of FIG. 6. The event can be actively sent (i.e. pushed by the interactive travel information system 140) or requested (i.e. pulled) by the application system 130. Any events transmitted should be considered as user specific (e.g., information requested by the user at an earlier date). The foregoing represents one method by which an event can be contained within the application system 130.

Alternatively, the application system 130 may contain an information event that occurs when the application system 130 generates its own event. This event will be considered as non-user specific (e.g., a system or business rule has expired etc.). However, such events are still pertinent to the voice enabled interactive travel information system of FIG. 1. Once an event is contained within the application system 130, a decision must be made how to handle such events. During step 603, and provided that a decision is made to place a call, the application service 131 within the application system 130 sends an outbound call instruction to the call initiation mechanism 124 within the telephony/voice system 120 of FIG. 1. This call instruction typically contains the telephone number to be called, instructions for the system in the case of a successfully placed call, and instructions for the system in case of an unsuccessfully placed call. It should be recognized that the application service 131 does not necessarily have to act immediately upon receiving an event. The business rules that are established and in place at the time of the information event will determine the actions to be taken in view of particular events given a particular state of conditions. Inasmuch as FIG. 6 relates only to outbound call initiation, a detailed discussion of the timeliness of the actions taken by application service 131 has been omitted. Nevertheless, and by way of example only, the application service 131 would typically store an event to be handled later or deleted (e.g., if a user instructed the system not to call between certain hours of the day or if a user were no longer active within the system).

During step 604 of FIG. 6, the telephony/voice system 120 initiates a call to the user 100. Upon receiving the outbound call instruction, the telephony/voice system 120 will place an outbound call to the user. Such outbound call would be accomplished over the telephony network 110. The call will either be completed successfully to the user or, for a variety of reasons, the call will be unsuccessful. In the event that the call to the user is successful, the telephony/voice system 120 requests an initial voice instruction set from the application system 130 during step 605 of FIG. 6. The initial instruction set can be prestored or retrieved at the time of the inbound call. The initial request can also include information derived from the telephony network 110 such as the caller ID or the number that was dialed (DNIS). Information will also be sent back to the application system 130 regarding the identity of the caller (i.e., whereby to return information that was originally supplied by the application system 130).

Provided that the outbound call was successful, the application service 131 of application system 130 of FIG. 1 returns the instruction set to the telephony/voice system 120 during step 606 of FIG. 6. The application service 131 within the application system 130 returns an initial voice instruction set to the telephony/voice system 120 which is delivered to the voice instruction interpreter 123 thereof. This instruction set can be more detailed than the example described when referring to step 604 of FIG. 6, inasmuch as the application service 131 should now be aware of the identity of the user being called and the reason for the call. During step 607, normal user interaction begins. That is, the normal user-to-system interaction occurs (see line 700 of FIG. 7).

In the event, however, that the outbound call that was placed during step 604 of FIG. 6 was unsuccessful, then, during step 610, the telephony/voice system 120 notifies the application system 130 that the outbound call was not successfully completed. The telephony/voice system 120 should be capable of relaying back to the application system 130 the reasons for unsuccessful outbound calls in cases where it is desirable to create a robust and intelligent voice enabled interactive travel information system. By way of example, an outbound call may be unsuccessful in the event that the telephone of the user is busy, the telephone number of the user is invalid, the user was not available to access his telephone, the telephony network 110 was busy, etc.

Finally, during step 611 of FIG. 6, the application service 131 of application system 130 takes appropriate action according to the business rules in place. That is, upon notification that a call was not successfully completed to the user, the application service 131 will respond in a manner that is determined by the existing business rules. By way of example, the application service 131 of application system 130 may instruct the telephony/voice system 120 to try a new call to the user, to simply discard the event that initiated the outbound call, store the event that initiated the outbound call to be tried again in the future, notify the interactive travel information system, etc.

FIG. 7 of the drawings illustrates the normal cycle by which a user 100 interacts with the voice enabled interactive travel information system that has been heretofor described while referring to FIGS. 1-6. The user interaction cycle is typically initiated when the user calls the interactive travel information system or when the system calls the user. Once a call is enabled, the interaction cycle will repeat until the call has been terminated. It should be recognized that a call can end for a variety of reasons (e.g., such as where the user hangs up). In the alternative, the voice/telephony system 120 is also capable of terminating a call at any time. Additional processing and system interaction may continue after a call is terminated. For example, if the user hangs up, the voice/telephony system 120 may choose to notify the application system 130 of a hang up condition, and the application service (designated 131 in FIG. 1) of the application system 130 may choose to make a record that the user has terminated the call at a specific time. For purposes of simplicity, such processing and system interaction after a call has been terminated will not be described when referring to FIG. 7. Therefore, FIG. 7 is provided only to illustrate the normal user-to-system interaction cycle that is associated with the voice enabled interactive travel information system shown in FIG. 1.

During normal entry 700, it is assumed that an inbound or outbound call has already been connected (as previously described when referring to FIGS. 5 and 6), that the application system 130 is aware of the connected call, and that the application system 130 has delivered an appropriate instruction set to the voice/telephony system 120. The voice instruction interpreter 123 of the telephony/voice system 120 of FIG. 1 receives an information/instruction set during step 727 for further processing. During step 728, the voice instruction interpreter 123 processes the voice information/instruction set that has been delivered by the application service 131 of the application system 130 of FIG. 1 and distributes voice output instructions to the speech/text-to-speech engine 121 of the telephony/voice system 120. At the same time, a valid input recognition set is sent to the speech/DTMF recognition engine 122 of telephony/voice system 120.

The output instructions and recognition set are typically in the form of text (in the case of the speech/text-to-speech engine 121) or text and numbers (in the case of the speech-DTMF recognition engine 122). For example, it may also be necessary to send pronunciation instructions to the speech/text-to-speech engine 121 or to the speech/DTMF recognition engine 122. In addition, the output construction or input set can be further encoded by a propriety scheme. Moreover, it is also possible for either of the output instructions or input set to be empty. In the case of an empty recognition set, the system will typically wait for any user input, or the telephony/voice system 120 will simply continue to operate after the speech/text-to-speech engine 121 has finished delivering its output. In the case of empty output instructions, the system will simply not deliver any content to the user and will expect the user to understand what to enter without any prompting. In this same regard, it should be understood that the voice information/instruction set should also contain instructions for taking action once a particular input has been derived. As the telephony/voice system 120 must typically interact only with the application system 130, the instructed response from system 120 should be in a form that will be understood by application system 130.

During step 729, the speech/text-to-speech engine 121 of telephony/voice system 120 sends output to the telephony network 110 to be ultimately delivered to the user 100. However, the speech/text-to-speech engine 121 should have the capability of delivering other forms of prompting that will be understood by the user. For example, the engine 121 should be able to deliver prerecorded audio, DTMF, etc.

During step 711, audio is transmitted from the telephony/voice system 120, through the telephony network 110, for receipt at the user's telephone device 101, 102 or 103 to be heard by the user 100. Next, at step 710, the user responds to the audio message he hears. That is, after being prompted (if there is a prompt available to the user), the user 100 responds accordingly. In this case, the user may either speak his response or press appropriate audio tone keys on his telephone device (DTMF).

The speech/DTMF recognition engine 122 of the telephony/voice system 120 of FIG. 1 receives the user's response at step 720 of FIG. 8. The response of the user is transferred over the telephony network 110 back to the telephony/voice system 120 where it is then delivered to the speech/DTMF recognition engine 122. The recognition engine 122 searches its input recognition set for a match. Recognition engine 122 can take different actions depending upon whether a match has been made.

In the case of an unsuccessful match between the response of the user and the input recognition set of the recognition engine 122, then the user is reprompted during step 722. For example, voice/telephone system 120 will typically reprompt the user if the user was not heard or understood. However, the system should also be capable of taking other actions. For example, system 120 could simply report to the voice instruction interpreter 123 thereof that no match was found. At this point, the call would be terminated.

If, however, there was a successful match between the response of the user and the input recognition set of the recognition engine 122, then the recognition engine transmits a response to the voice instruction interpreter 123 of the telephony/voice system 120 of FIG. 1 during step 723. The speech/DTMF recognition engine 122 will typically notify the voice instruction interpreter 123 of a successful match and deliver the input that has been recognized. Although it is not required, the recognition engine 122 should preferably be capable of delivering meta data that is associated with the user's response. For example, the recognition engine 122 could deliver a confidence level in the match, a recording of the user's input, etc.

Provided that there was a successful match, the voice instruction interpreter 123 will receive and interpret the response from speech/DTMF recognition engine during step 724. In this case, the voice instruction interpreter 123 must evaluate the response and then decide on the next action to be taken. Typically, the decision to be made by the voice instruction interpreter 123 is relatively simple and is dependent upon whether the voice instruction interpreter 123 has accumulated a complete information set that is based on the original instruction set it was provided during step 728. However, the voice instruction interpreter 123 may make several complicated calculations. Such calculations could be based on the confidence level returned by the speech/DTMF recognition engine 122, how long the user took to respond, etc. The level of detail of the calculations made by voice instruction interpreter 123 is not necessary to an understanding of this invention and will not be described in FIG. 7.

If the instruction set that is required has not been sufficiently fulfilled, then the voice instruction interpreter 123 will send further output instructions and input sets to the appropriate components of the interactive travel information system (see prior step 728). Such further instructions would typically be sent when the original information/instruction set that was supplied to voice instruction interpreter 123 was either large or multi-leveled or could not be fulfilled with a single round of interaction with the user 100.

On the other hand, if a complete information set is accumulated, then the voice instruction interpreter 123 of telephony/voice system 120 translates the response during step 725. That is, depending upon the input from the speech/DTMF recognition engine 122 and the original instruction set, the voice instruction interpreter 123 builds a response information set. This response information set typically represents the interpreted input of the user 100 as well as the action to take with the input set. For example, depending upon the user's input, the voice instruction interpreter 123 could be directed to deliver the input to different places within the interactive travel information system. This information set can also contain additional information such as a recording of what the system heard, a confidence level, etc.

The telephony/voice system 120 transmits the converted response information set to the application system 130 during step 826. The response instruction set transmitted to application system 130 can take any suitable form that is determined by the contract between voice/telephony system 120 and application system 130 (e.g., XML could be passed, a remote procedure call could be made, an http post could be sent, etc.). However, the precise method or format by which the intended information is passed will not be explained in FIG. 7.

Next, the application service 131 of application system 130 receives and interprets the response from the voice/telephony system 120 during step 750. After receiving a response, the application service 131 will typically fulfill a predetermined business rules action. However, the precise level of detail of the business rules action to be completed by application service 131 will not be described in FIG. 7.

After processing the response from the voice/telephony system 120, the application system 130 must determine if interaction will be required with the interactive travel information system 140. In the event that interaction between application system 130 and interactive travel information system 140 is not necessary, then the application service 131 of application system 130 generates a voice/information instruction set during step 754. In general, even if no interaction is necessary with the interactive travel information system 140, the application service 131 will always generate a return instruction set for the telephony/voice system 120 (except in the case where the telephony/voice system 120 has notified the application system 130 that the user has hung up and terminated the call). Otherwise, the user would be left hanging while awaiting a further communication from the interactive travel information system. If interaction between application service 130 and interactive travel information system 140 is not necessary, the generated information/instruction set will typically contain additional menu navigation or prompting to gain further information from the user. However, in the case where interaction is required, the information/instruction set will typically contain a transaction of the response from the interactive travel information system 140 and corresponding prompting and instructions for subsequent actions to be taken. Provided that interaction with the interactive travel information system 140 is not required, then the application service 131 of application system 130 will now transmit the information/instruction set to the voice/telephony system 120 for further processing and user interaction during step 755.

In the event that interaction is otherwise required between the application system 130 and the interactive travel information system 140 of FIG. 1 during step 750, then the application service 131 of application system 130 translates the response instructions into action instructions during step 751. When enough information has been accumulated to warrant an interaction with the interactive travel information system 140, the application system 130 generates information instructions. It should be recognized that the instructions generated by the application system 130 do not necessarily need to reflect directly upon the response instructions of the voice/telephony system 120. That is, due to predetermined business rules, the application system 130 can, at any time, request a refresh of the profile of a user from the interactive travel information system 140.

Next, during step 752, the application service 131 of application system 130 transmits the information instructions to the interactive travel information system 140. These instructions can be in any suitable form that is determined by the contract between the application system 130 and the interactive travel information system 140 (e.g., XML could be passed, a remote procedure call could be made, an http post could be sent, etc.). However, the precise method or format by which the intended information is transmitted will not be explained in FIG. 7.

During the next step 770, the interactive travel information system 140 receives the information instructions from the application service 131 of application system 130. After receiving the travel information instructions, the online travel service 141 of interactive travel information system 140 will follow its predetermined business rules and take appropriate internal action. For purposes of simplicity, it is assumed that a request/response relationship exists between the application system 130 and the interactive travel information system 140. Accordingly, a portion of the responsibility of interactive travel information system 140 during this interaction will also be to generate an information response set.

In this case, the interactive travel information system 140 transmits the information response set to the application system 130 during step 771. This transmission from interactive travel information system 140 can be in any suitable form as determined by the contact between application system 130 and interactive travel information system 140 (see step 752).

Finally, during step 753, the application service 131 of application system 130 receives the information response set. The application service 131 may need to perform additional tasks prior to generating a response to the user 100. However, the precise nature of such additional tasks will not be described in of FIG. 7.

It is to be understood that the voice enabled interactive travel information system herein described is capable of receiving and transmitting dynamically generated content concerning online travel information events in different forms including, but not limited to, XHTML, HTML, SMIL, WML, XML, VXML, SALT, SOAP, JavaScript, CSS, SVG, SyncML, ECMAScript, Java, WAV, and MP3 and converting such content into interactive voice responses. Communication between the user's telephone device (e.g., 101, 102 or 103) and the telephony network 110 to permit interaction between the user and the telephony/voice system 120 may use internet protocol (IP), wireless application protocol (WAP), voice over IP (Voip), or any other suitable protocol.

1. An interactive travel information system by which to convert online travel specific information relating to travel information events, content and object data generated by an online travel company or travel information provider into interactive voice communications for transmission to a user, said interactive system comprising:
an application system to receive the travel specific information generated by the online travel company or travel information provider and to convert said travel specific information into voice content and instructions;
a telephony/voice system to receive the voice content and instructions produced by said application system and to generate an interactive voice response to said voice content and instructions;
a telecommunications network by which to transmit the interactive voice response generated by said telephony to the user; and
a telephone at which the user receives the interactive voice response transmitted by said telecommunications network.

2. The interactive travel information system recited in claim 1, wherein said telecommunications network is one of a cellular telephone network, a mobile telephone network, a satellite telephone network, or a public switched telephone network.

3. The interactive travel information system recited in claim 1, wherein said telephone of the user is one of a mobile telephone, a cellular telephone, a terrestrial telephone, or a satellite telephone.

4. The interactive travel information system recited in claim 1, wherein said telephony/voice system has means communicating with said application system by which to receive an outbound call instruction and thereby initiate an outbound call to the telephone of the user by way of said telecommunications network, said telephony/voice system also having means by which to accept an inbound call from the telephone of the user by way of said telecommunications network.

5. The interactive travel information system recited in claim 4, wherein the means of said telephony/voice system to accept an inbound call from the telephone of the user is responsive to at least one of the voice of the user or audio tones (DTMF) generated by the user on the telephone of the user.

6. The interactive travel information system recited in claim 5, wherein the means of said telephony/voice system to accept an inbound call that is responsive to at least one of the voice of the user or the audio tones generated on the telephone of the user is a speech/DTMF recognition engine that is adapted to convert the user's voice and the audio tones into corresponding voice/DTMF commands.

7. The interactive travel information system recited in claim 6, wherein said telephony/voice system also includes a voice instruction interpreter interconnected between said speech/DTMF engine and said application system so as to receive said voice/DTMF commands and to provide to said application system corresponding response instructions to be delivered from said application system to the interactive travel information system as information instructions.

8. The interactive travel information system recited in claim 7, wherein said telephony/voice system also includes a speech/text-to-speech engine communicating with said voice instruction interpreter, said voice instruction interpreter receiving the voice content and instructions produced by said application system and generating voice output instructions in response thereto, said speech/text-to-speech engine receiving said voice output instructions and transmitting to said telecommunications network understandable human speech that is based on said voice output instructions generated by said voice instruction interpreter.

9. The interactive travel information system recited in claim 7, wherein said application system includes an application service that is adapted to convert the response instructions provided by the voice instruction interpreter of said telephony/voice system into information instructions to be delivered to the interactive travel information system.

10. The interactive travel information system recited in claim 9, wherein the application service of said application system generates said outbound call instruction to said telephony/voice system to initiate the outbound call to the telephone of the user, whereby to cause the travel specific information from the interactive travel information system to be transmitted to the user as understandable human speech.

11. The interactive travel information system recited in claim 9, wherein said application system also includes an application database communicating with said application service to provide information to and receive information from said application service.

12. The interactive travel information system recited in claim 1, wherein the travel specific information received by said application system and converted to voice content and instructions includes at least some travel specific items, a user profile containing travel items, notice of new profile event information, the current status of account, and advertising related events.

13. An interactive travel information system by which to convert online travel information and event information corresponding to travel service provider events, content and object data into understandable human speech to be presented to a user and to convert speech and/or DTMF audio generated by the user into information commands to be routed to an online interactive travel information system in response to the travel service provider or travel company event information, said interactive system comprising:
means to receive the travel event information from the interactive travel information system;
means to convert the travel event information into interactive responses as understandable human speech to be presented to the user;
a telephony network to deliver said interactive responses to the user; and
means communicating with said telephony network for converting the speech and/or DTMF audio response generated by the user into the information commands to be routed to the interactive travel information system.

14. The interactive travel information system recited in claim 13, wherein the means to convert the travel event information into interactive responses as understandable human speech to be presented to the user is a speech/text-to-speech engine.

15. The interactive travel information system recited in claim 14, wherein the means to convert the travel event information into interactive responses also includes a voice instruction interpreter communicating with said speech/text-to-speech engine to provide voice output instructions to said speech/text-to-speech engine corresponding to the travel event information received from the interactive travel information system.

16. The interactive travel information system recited in claim 15, wherein said means communicating with said telephony network for converting the speech and/or DTMF audio responses generated by the user into information commands includes a speech/DTMF recognition engine communicating with said voice instruction interpreter so as to provide to said voice instruction interpreter voice/DTMF commands corresponding to said speech and/or DTMF audio responses generated by the user, said voice instruction interpreter providing output information in response to said voice/DTMF commands to be routed to the interactive travel information system as information commands.

17. The interactive travel information system recited in claim 13, further comprising call initiation means adapted to receive outbound call instructions and thereby initiate a call to the user by way of said telephony network so that the travel event information can be transmitted to the user.

18. A method for converting travel specific information relating to at least some of the travel information provider events or travel company events, content and object data into interactive voice responses to be delivered to a user, said method comprising the steps of:
generating electronic data packets containing the travel specific information obtained from a source of said information at an online travel information service provider or travel company;
converting the data packets into corresponding voice content and instructions;
generating an interactive voice response to said voice content and instructions;
generating an interactive voice response to said voice content and instructions as understandable human speech;
transmitting said interactive voice response to a telecommunications network; and
delivering said interactive voice response to the user by way of said telecommunications network.

19. The method recited in claim 18, including the additional steps of:
producing a user generated voice and/or audio (DTMF) signal in reply to said interactive voice response delivered to the user;
transmitting said user generated voice and/or audio signal from the user by way of said telecommunications network;
receiving and converting said user generated voice and/or audio signal into electronic information instructions; and
routing said information instructions to the interactive travel information system.

20. The method recited in claim 18, wherein the step of generating an interactive voice response to said voice content and instructions is accomplished by means of a voice instruction interpreter to receive said voice content and instructions and to provide corresponding voice output instructions, and a speech/text-to-speech engine communicating with said voice instruction interpreter to receive said voice output instructions and to provide said interactive voice response as understandable human speech.
